(19) United States
(12) Patent Application Publication
(10) Pub. No.: US 2015/0368086 A1
(43) Pub. Date: Dec. 24, 2015

(54) BEER TAP, SYSTEM AND ASSEMBLY INCORPORATING MOBILE APPLICATION TECHNOLOGY INCLUDING DATA COLLECTION, TRACKING AND TRANSMISSION SOFTWARE

(71) Applicant: David Michael Sacchetti, GROSSE POINTE WOODS, MI (US)

(72) Inventor: David Michael Sacchetti, GROSSE POINTE WOODS, MI (US)

(21) Appl. No.: 14/749,119

(22) Filed: Jun. 24, 2015

Related U.S. Application Data
(60) Provisional application No. 62/016,523, filed on Jun. 24, 2014.

(51) Int. Cl. B67D 1/08; G01F 23/00; B67D 1/14

(52) U.S. Cl. CPC B67D 1/0888; B67D 1/1477; B67D 1/0878; G01F 23/00

(57) ABSTRACT

A tap display, system and non-transitory computer writeable medium for managing a volume of dispensable product through a tap. A body includes a lower stem supporting end adapted to being mounted atop a fluid dispensing valve which is in fluid communication with the volume of dispensable product, the body having a display screen at a first location and an audial output at a second location. A first processor component is incorporated into the body and communicates with at least one of a visual and audial output. A second processor component is integrated into a processor driven device in communication with the first processor component and includes each of data collection, diagnostic and audio-visual output functions associated with the volume of dispensable product and outputted through the audial/visual outputs.

### CROSS REFERENCE TO RELATED APPLICATIONS

The present application claims the priority of U.S. Ser. No. 62/016,523 filed Jun. 24, 2014, the contents of which are incorporated herein in its entirety.

### BACKGROUND OF THE INVENTION

1. Field of the Invention

The present invention is directed to a beer tap with display which incorporates data collection, diagnostic and audio-visual output functionality. In one application, a processor driven device, such as a smart phone, laptop or tablet, incorporates a mobile application which interfaces with a processor (typically in either of WIFI/Bluetooth/Near Field Communication/Cell Technology or USB port connected fashion) associated with the beer tap display. The tap display can, according to one non-limiting protocol, include a normal operating screen (such as displaying a still or animated picture of a beverage product associated with the tap) and a diagnostic screen providing a numbers of output functions not limited to each of dispensing information including tap pulls, beer flow, keg status (temperature, remaining volume of product), battery and Wireless status, etc.

2. Background of the Relevant Art

The prior art is documented with examples of beverage dispenser tracking software and structure, such as is associated with tracking dispensing of beer from a standard kegerator. A first example of this is the fluid flow meter and open source software interface depicted in www.kegbot.org. In a most basic variant, kegbot provides a flow meter and associated wired or wireless capabilities interfacing with an Android® tablet interface for measuring fluid volumes dispensed from a beer keg or other fluid holding reservoir. Additional features include the ability to provide additional formatted data relating to keg status interface, statistics on individual drinkers, including providing individual accounts for crediting pours with the assistance of near field communication (NFC) technology.

The Anheuser-Busch/Sprint Interactive Tap Handle, a disclosure of which exists on-line at (http://newsroom.sprint.com/news-releases/anheuser-busch-and-sprint-score-big-time-with-interactive-tap-handles.htm) teaches a light up tap handle, such exhibiting flashing or message displays. The disclosure further indicates utilizing wireless machine to machine technology in combination with a cloud based platform for activating the tap handle display such as in response to a home team score in such as a sports bar setting.

U.S. Pat. No. 5,908,142, to Sacchetti, teaches an audio/visual display system incorporated into a beverage dispenser assembly, the dispenser assembly including a spigot, a flow/non-flow dispensing handle operatively engaging the spigot and a selected beverage for dispensing through the spigot. A structure is arrayed atop the dispenser assembly and includes an advertising display for presenting visual advertising including both textual and graphical components.

### SUMMARY OF THE PRESENT INVENTION

The present invention provides a combination beer tap system, assembly and processor based computer writeable medium for managing the dispensing of a fluidic product from a volume holding source. The present invention further combines, in a manner not disclosed or rendered obvious by the prior art, an interactive and beer tap associated with a kegerator which combines a viewing screen integrated into a beer tap handle which is capable of playing video, audio and still pictures.

The audio/visual display system is incorporated into a beverage dispenser assembly and includes a spigot, a flow/non-flow dispensing handle operatively engaging the spigot and a selected beverage for dispensing through the spigot. The viewing screen is arrayed atop the dispenser assembly and includes, as part of the video, audio and still picture aspects, also presents both audio and visual advertisements, including both textual and graphical components.

A wireless charging station is provided in operative communication to the kegerator structure and tap handle in order to power the audio/visual display. The display housing can also include a camera for taking or recording video, still pictures, and the like.

A central processor unit is either incorporated into the structure in communication with the advertising display or provided in a stand-alone computerized hard drive which is connected to the structure. The processor unit is capable of storing audio/visual messages, being inputted with custom created messages and presenting menu displays corresponding to stored messages. An accompanying audio playback component is arranged in operative communication with an output of the processor unit and is either provided with an audio playback transducer incorporated within the display system structure or as a stand-alone speaker arranged in proximity to the display system.

A non-transitory computer writeable medium for managing a volume of dispensable product through a tap is provided in use with a processor driven device and incorporates a mobile software application which is in operative communication with a tap body including a lower stem supporting end adapted to being mounted atop a fluid dispensing valve which is in fluid communication with the volume of dispensable product. The body has a display screen at a first location and an audial output at a second location.

The software application includes a first subroutine associated with a normal operating mode for communicating a first audial/visual output to said tap which is related to the dispensable product. The software application including a second subroutine associated with a diagnostic mode for tracking and monitoring a plurality of variables associated with the quality, condition and remaining volume of the dispensable product. The second subroutine further includes the ability to track dispensing information including any of tap pulls, beer flow, keg status (temperature, remaining volume of product), battery and Wireless status.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a general representation of a beer tap associated with one possible application of the present invention and which depicts such as an animated or still picture (such as associated with the brand of beer being dispensed) in a first normal display mode;

FIG. 2 is a succeeding illustration of the beer tap of FIG. 1 and further illustrating a second diagnostic mode associated with a series of software application related functions, this including a series of capacitive touch locations and which interface with either a built in or separate processor, such as via any one or more of USB/WiFi/Bluetooth connections;

FIG. 3 is a block diagram of the hardware components associated with the system and assembly of the present invention;

FIG. 4 is a schematic illustration of features associated with both the normal and diagnostic modes of operation depicted in the tap display of FIGS. 1-2; and

FIG. 5 is an illustration of a wireless charging station integrated into the tap assembly.

### DETAILED DESCRIPTION OF THE PREFERRED EMBODIMENTS

As previously referenced, the present invention is directed to an inventive modernization of a beer tap display, as well as an associated system and non-transitory computer writeable medium which interfaces with a mobile application, such as which can be utilized along with a separate processor associated with a processor driven device including any of a laptop, tablet or smartphone. In this fashion, a separate processor component built into the tap display can interface with the separate processor device and, in operation, incorporates data collection, diagnostic and audio-visual output functionality.

In one application, the separate processor driven component built into the tap can interface with the output functions associated with the separate processor associated with the mobile application for outputting information to an output display screen integrated into the tap (this typically occurring in either of WIFI/Bluetooth/Near Field Communication or USB port connected fashion) associated with the beer tap display. The tap display can, according to one non-limiting protocol, include a normal operating screen (such as displaying a still or animated picture of a beverage product associated with the tap) and a diagnostic screen providing a numbers of output functions not limited to each of dispensing information including tap pulls, beer flow, keg status (temperature, remaining volume of product), battery and Wireless status, etc.

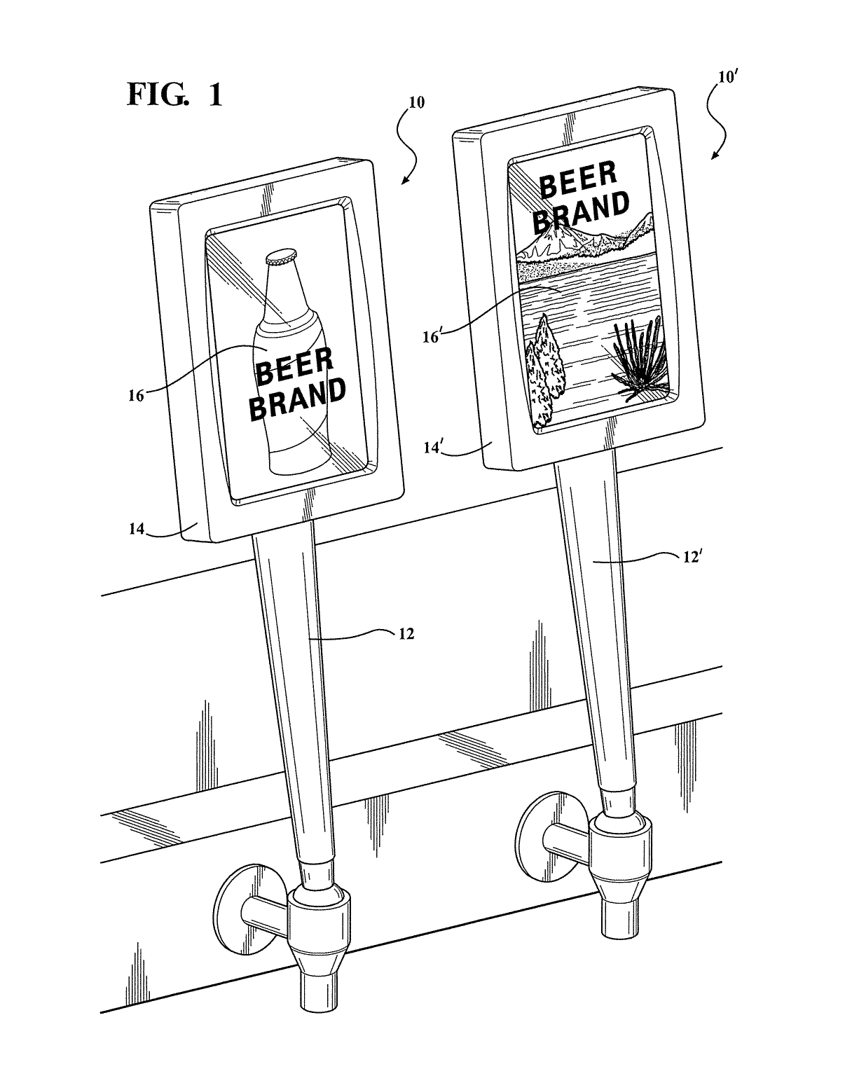

With the above explanation, and referencing initially FIG. 1, a general representation is shown at 10 of a pair of beer taps associated with one possible application of the present invention. The taps indicated in the display 10 are understood to include any structure suitably mounted atop a beer tap on/off valve and which can include a body typically having a mounting stem, see at 12 and 12′ and such as is known to be mounted upon the valve. Each of the stem bodies supports an upper superstructure 14 and 14′, such further exhibiting a suitable display screen 16 and 16′ with associated video and audio output capabilities.

As will be further described, the beer tap handle is capable of providing any one or more of video, audio and still images, such as branding or signage specific to the brand of beer being dispensed (see reference to beer brand logo for display 16 as well as related logo and background display 16′ in FIG. 1). In one non-limiting variant, the commercialization aspects of the tap handle construction are such that the display screen can provide a combination of commercial and entertainment related features, such further including branding and product identification which can be variable with the digital input/media provided, thereby dispensing with the need for changing the entire tap handle design.

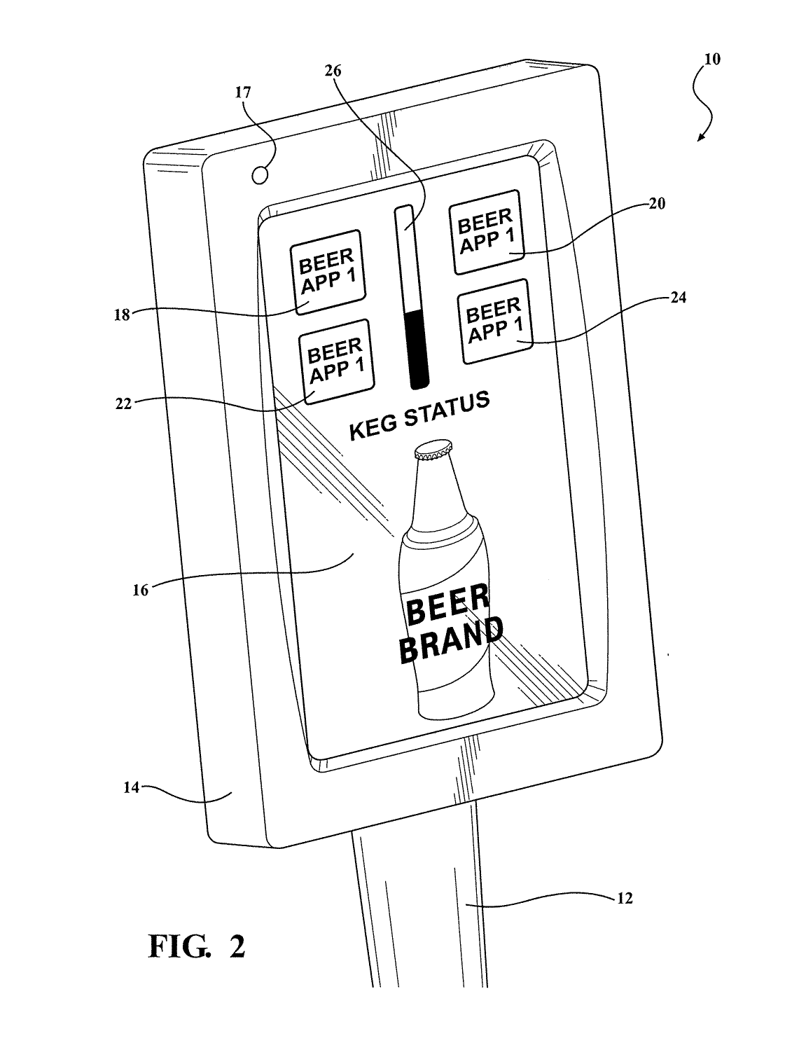

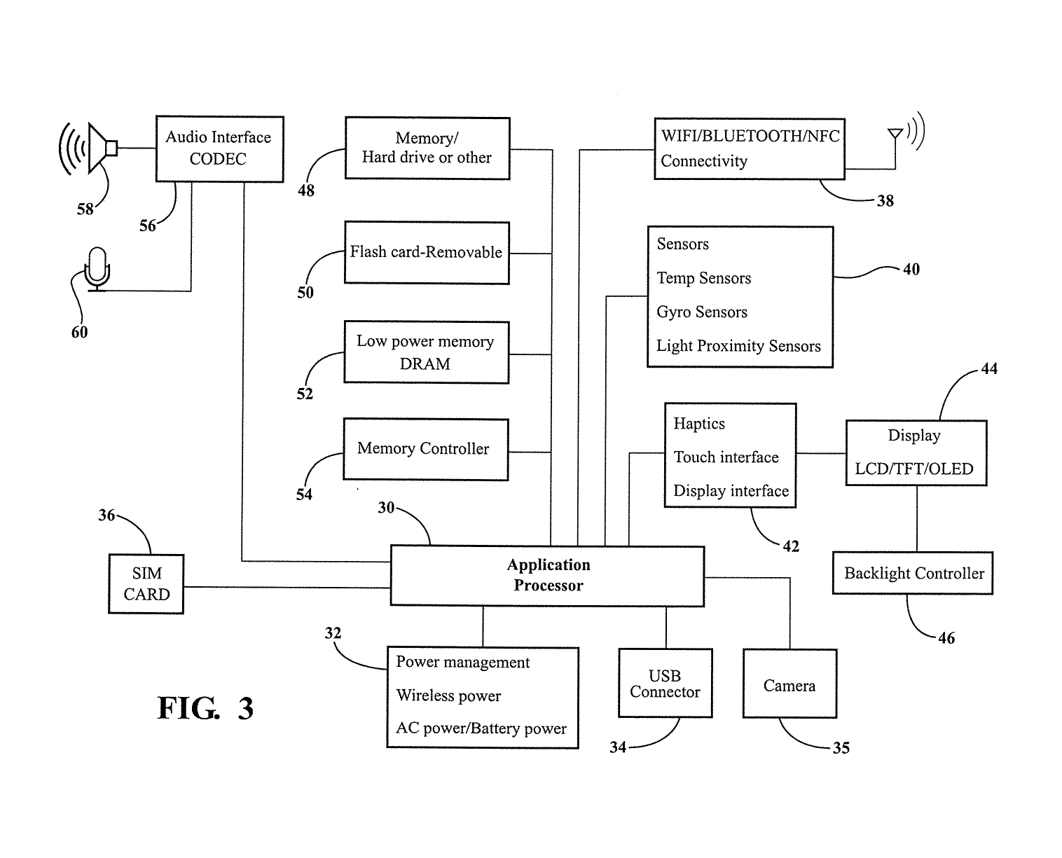

As further shown in FIG. 2, the display or upper body housing 14 can also integrate a digital camera (see lens 17). Similar to existing smart phones, the camera can be integrated into the processor architecture (see also FIG. 3) and can either record or play video or still pictures.

A processor (see as subsequently described in FIG. 3) is generally understood to include, in one non-limiting embodiment, at least one component which is integrated into the body of the tap 10 in such a fashion that it communicates with the display screen 16 (such further typically including in one non-limiting application a capacitive touch screen. Other known screen display technologies can also be utilized according to that known in the relevant art and include such as resistive touch screens or the like. Additional features associated with the tap 10 can include either a built-in power supply (such a rechargeable Li ion batteries or the like) or can even incorporate wireless charging technology for powering the display.

As is separately discussed in the block diagram of FIG. 3, the tap 10 also includes any combination of audio visual output not limited to still and/or animation video, as well as sound such as derived by a sound card, such as is built into the processor component associated with the tap and which can include digital to analog converter (DAC), this in turn communicating with a sound amplifier which is built into the display. In one non-limiting operation, the tap is capable of separately presenting or combining any combination of audio visual outputs, such including either color and/or black and white stills or video, this along with or apart from any audio output which can also be produced utilizing both the software and hardware components built into the system and non-transitory computer writeable medium.

Given the above, and referring again to FIG. 1, screen 16 of tap 10 is illustrated in a first normal display mode, such as which can include any form of animated or still picture (such as associated with the brand of beer being dispensed). Although not shown, any suitable audial output can be provided separately or in combination with the visual display, such as in certain instances potentially including any jingle or sound output which may reference the brand of the beverage being dispensed.

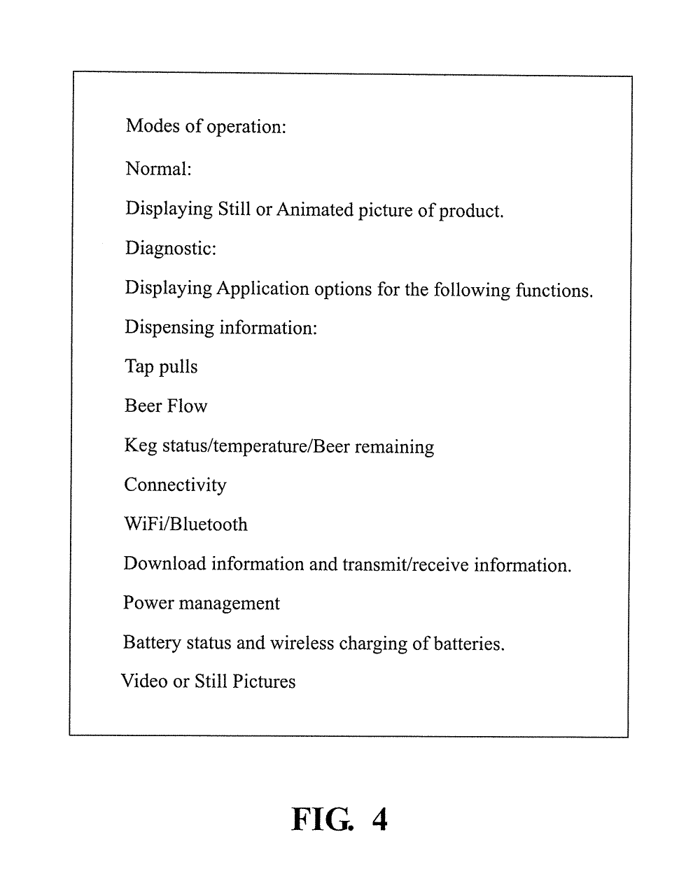

FIG. 2 is a succeeding illustration of the beer tap of FIG. 1 and further illustrating a second diagnostic mode associated with a series of software application related functions, this including a series of capacitive or resistive touch locations and which interface with either a built in or separate processor, such as via any one or more of USB/WiFi/Bluetooth (or other NFC) connections. With reference to associated schematic display of FIG. 4, the diagnostic/display of FIG. 2 can include buttons or locations referencing each of Beer App 1 (at 18), Beer App 2 (at 20), Beer App 3 (at 22) and Beer App 4 (at 24), this further along with keg status 26 and subset diagnostic screen or animated/still picture of brand of beer at 28.

In one non-limiting application, the Beer Apps 18-24 can reference subset programs associated with a given dispensing tap and which, when individually accessed, can provide any one or more diagnostic function including number of tap pulls, beer flow (temperature and CO2 pressurization which can include the addition of sensors located at the keg and pressure fittings and communicating their output readings to the display). Also provided is a separate reading for a remaining volume of beer in the keg, such as which can further be ascertained in a number of different ways including pre-programming an original volume of beer associated with a half barrel (1984) or a quarter barrel (992) into the process and then volumetrically calculating through the incorporation of a separate sensor into the dispensing valve which communicates with the tap to display a remaining non-dispensed volume.

Other variants can include incorporating a digital scale into the kegerator housing and inputting the necessary variables for tracking calculated weights between full and empty conditions of the keg supported thereupon, such corresponding to remaining volumes. The digital scale can include in input line (or wireless, Bluetooth or Near Field Communication input signal) extending to or communicating with the processor components as will be described below in order to establish and maintain real time tracking of fluid volume dispensing (such as an alternative to liquid flow meters which may be somewhat less accurate).

Additional diagnostic output readings can include each of connectivity status (WiFi/Bluetooth/Near Field Communication (NFC), two way (download and transmit) information management, power management, battery status and wireless charging of batteries.

FIG. 3 is a block diagram of the hardware components associated with the system and assembly of the present invention and which references an application processor 30 (this generally depicting any combination of a remote processor with mobile application software in interfacing communication with the built in processor associated with the tap 10. As previously described, the present invention contemplates the ability to tie in any number of wireless sensors associated with selected functions of the beer keg, kegerator and tap with a software program, such as associated with a mobile application loaded into a portable PC driven device and in order to manage any number of beer kegs and associated taps.

The processer 30 includes a first pair of input/output connections associated with each of Power management/Wireless Power/AC power/Battery Power 32, USB connecter 34 and digital camera 35. A SIM card slot 36 (also termed a micro SD card) is also referenced for providing both additional storage capacity and memory for the tap display and is envisioned to be capable of being mounted in one non-limiting variant to an input slot associated with the tap 10.

A WiFi/Bluetooth/NFC connectivity feature 38 with antenna is shown in input/output communication with the controller 30. A plurality of sensors, collectively depicted at 40, likewise communicate with the processor 30 and include any one or more of weight (e.g. digital scale similar to as previously described), volume, light, motion (gyro) and light proximity sensors, these further including both wired and wireless sensors.

Touch interface functions 42 (haptics, touch interface, and display interface) are also referenced and, as known, can include any known technology such as capacitive/resistive touch or the like. Interface functions 42 communicate with display feature 44 (see also FIGS. 1-2) which can include any of liquid crystal display (LCD), thin film transistor (TFT) or organic light emitting diode (OLED) variants. Backlight controller function 46 is in communication with an output of display feature 44.

Additional memory and output functionality in two way communication with the processor further includes each of a memory/hard drive 48, a removable flash card 50, a low power memory notification feature/dynamic random access memory (DRAM) which is a type of random access memory which stores each bit of data in a separate capacitor within an integrated circuit. Finally, an audio interface, or alternately a coder/decoder (CODEC) which is defined as a computer program capable of encoding or decoding a digital data stream or signal. Communicating with the audio interface is each of a speaker output 58 and a microphone input 60, such as are further known in video conferencing type applications associated with CODEC formats.

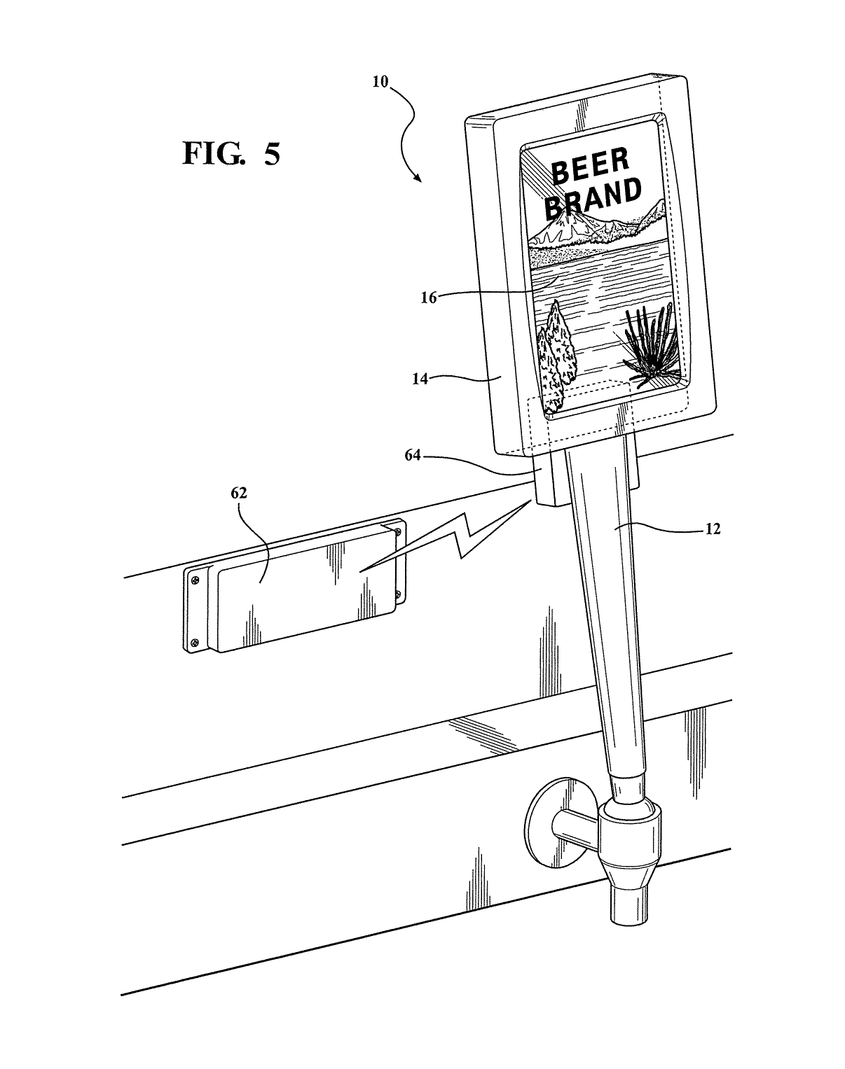

Finally, FIG. 5 is an illustration of a wireless charging subassembly which can be mounted in proximity to the tap superstructure and which includes a power transmitting unit 62 mounted to a proximate base location of the kegerator superstructure in wireless communication with a receiver unit 64 mounted to the tap stem 12 in direct communication with the upper superstructure 14 with built in display screen 16. In one non-limiting variant, the transmitter unit 62 can include either or both a battery supply or a direct wire feed from a remote power source (e.g. AC wall outlet). Without limitation, the present invention also contemplates any number of variants in which power can be directly fed, via wires, to the tap and display or a further modification of the display or any type of attached receiver unit.

Having described my invention, other and additional preferred embodiments will become apparent to those skilled in the art to which it pertains and without deviating from the scope of the appended claims. This can include providing the processor features described above in a mobile application, such as for a smartphone, tablet or laptop, such as which can constitute the application processor previously identified at 30 and which communicates with the various input features identified in FIG. 3.

The mobile application can further include a series of screen displays and associated subroutines which provide the desired features and functionality described herein, such as including but not limited to the commercialization and branding objectives provided by the multi-media output features. Additional functionality includes the ability to generate usage reports and the like relating to consumption and related variables.

I claim:

1. A tap with display, comprising:
a body including a lower stem supporting portion adapted to being mounted atop a fluid dispensing valve which is in fluid communication with a volume of dispensable product, said body further having an upper display supporting portion; and
a processor incorporated into said body and communicating with at least one of a visual or audial output, said processor including each of data collection, diagnostic and audio-visual output functions associated with the volume of dispensable product and outputted through said audial/visual outputs.

2. The tap as described in claim 1, further comprising a wireless charging station situated in proximity to said body.

3. The tap as described in claim 1, further comprising a digital camera integrated into said upper display supporting portion.

4. A system for managing a volume of dispensable product through a tap, comprising:
a body including a lower stem supporting portion adapted to being mounted atop a fluid dispensing valve which is in fluid communication with the volume of dispensable product, said body having an upper display supporting portion with both video and audio output capabilities;
a first processor component incorporated into said body and communicating with at least one of a visual or audial output associated with said upper display supporting portion; and
a second processor component integrated into a processor driven device in communication with said first processor component and including each of data collection, diagnostic and at least one of audio or visual output functions associated with the volume of dispensable product and outputted through said audial/visual outputs.

5. The system as described in claim 4, said processor driven device further comprising any of a smart phone, laptop or tablet incorporating a mobile software application which interfaces with said first and second processor components.

6. The system as described in claim 5, further comprising a communication protocol established between said processor driven device and said tap body and including any of WIFI, Bluetooth/Near Field Communication, Cell Technology, or USB port connected fashion.

7. The system as described in claim 4, said display screen further comprising a touch interface.

8. The system as described in claim 4, further comprising a plurality of sensors associated with said volume of dispensable product and a containment, chilling and pressurization mechanism for managing said product, said sensors interfacing with said processor components for managing and tracking a plurality of variables according to each of the data collection, diagnostic and audio-visual output functions.

9. The system as described in claim 4, further comprising a wireless charging station situated in proximity to said body.

10. The system as described in claim 4, further comprising a digital camera integrated into said upper display supporting portion.

11. A non-transitory computer writeable medium for managing a volume of dispensable product through a tap, comprising:
a processor driven device incorporating a mobile software application and which is in operative communication with a tap body including a lower stem supporting portion adapted to being mounted atop a fluid dispensing valve which is in fluid communication with the volume of dispensable product, said body having an upper display supporting portion with both visual and audio output capabilities;
said software application including a first subroutine associated with a normal operating mode for communicating a first audial/visual output to said tap which is related to the dispensable product; and
said software application including a second subroutine associated with a diagnostic mode for tracking and monitoring a plurality of variables associated with the quality, condition and remaining volume of the dispensable product.

12. The computer writeable medium as described in claim 11, said second subroutine further comprising tracking dispensing information including any one or more of tap pulls, beer flow, keg status (temperature, remaining volume of product), battery and Wireless status.

13. The computer writeable medium as described in claim 11, further comprising a third subroutine for recording at least one of video or still images from a digital camera mounted to said body.
